(19) United States
(12) Patent Application Publication
(10) Pub. No.: US 2005/0172140 A1
(43) Pub. Date: Aug. 4, 2005

(54) Encryption device, encryption system including the encryption device, decryption device and a semiconductor system including the decryption device

(75) Inventor: Takashi Ide, Amagasaki-shi (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/038,045

(22) Filed: Jan. 21, 2005

(30) Foreign Application Priority Data
Jan. 30, 2004 (JP) 2004-022475

(51) Int. Cl. G06F 12/14

(52) U.S. Cl. 713/190; 713/188

(57) ABSTRACT

A data/code conversion device receives confidential information, converts the confidential information into instruction codes for making a CPU provided in a semiconductor device perform its operation, and stores the instruction codes as dummy instruction codes in an external memory. One of the confidential information of which corresponding instruction code does not exist is converted into another instruction code as a dummy instruction code and stored, and correction data for reconstructing the confidential information from the instruction code is also stored in the external memory. In the semiconductor device, a decryption circuit for receiving the dummy instruction codes and the correction data stored in the external memory and performing decryption to obtain the confidential information is provided. Therefore, leakage of confidential information stored in the external memory can be reliably prevented with a relatively simple structure, so that the security level is increased.

### CROSS REFERENCE TO RELATED APPLICATIONS

This non-provisional application claims priority under 35 U.S.C. § 119(a) on Patent Application No. 2004-22475 filed in Japan on Jan. 30, 2004, the entire contents of which are hereby incorporated by reference.

### BACKGROUND OF THE INVENTION

The present invention relates to encryption and decryption devices for protecting, when confidential information is stored in an external memory, the confidential information in the external memory for storing an instruction code and data for operating a semiconductor device such as a general-purpose microcontroller included in a semiconductor system.

Conventionally, in a semiconductor system including a semiconductor device and a memory disposed outside of the semiconductor device, when confidential information is stored in the external memory, for example, as in Japanese Laid-Open Publication No. 11-191079, a cryptogram obtained by encrypting the confidential information is stored in the external memory and the cryptogram is decrypted in the semiconductor device, whereby leakage of confidential information is prevented.

However, with the known structure for protecting confidential information, as an encryption scheme becomes more complicated, hardware and software resources of the semiconductor device required for decrypting a cryptograph are tend to be increased. Moreover, every time a different encryption scheme is adopted, a large scale hardware and software designing has to be done.

### SUMMARY OF THE INVENTION

It is therefore an object of the present invention to provide an encryption device and a decryption device with a relatively simple. circuit structure which can prevent leakage of confidential information

To achieve the above-described object, according to the present invention, confidential information is incorporated in an external memory not as data but a dummy instruction code for the semiconductor device.

Specifically, an encryption device for encrypting confidential information in an external memory for storing instruction codes and data for controlling a semiconductor device and the confidential information to be a subject of protection against information leakage, the semiconductor device and the external memory composing a semiconductor system, is characterized by comprising: a code conversion device for converting the confidential information into the instruction codes and storing in the external memory the confidential information as dummy instruction codes.

In one embodiment of the present invention, the encryption device is characterized in that the code conversion device includes a conversion circuit for converting, when an instruction code corresponding to the confidential information does not exist, the confidential information into another instruction code to generate a dummy instruction code, and generating correction data for reconstructing the confidential information from the dummy instruction code.

In one embodiment of the present invention, the encryption device is characterized in that the code conversion device includes a final data/code generation device for receiving the dummy instruction code, the correction data, the instruction codes and the data and having the dummy instruction codes embedded in the instruction codes and the correction data embedded in the data to generate final instruction codes and final data to be stored in the external memory.

In one embodiment of the present invention, the encryption device is characterized in that the final data/code generation device includes: a plurality of conversion tables for converting the correction data into the final correction data; and a correction data conversion circuit for converting the correction data into final correction data using one of the plurality of conversion tables.

In one embodiment of the present invention, the encryption device is characterized in that the final data/code generation device includes a final data generation circuit for receiving final correction data from the correction data conversion circuit and the data, allocating the final correction data in the data to output the data including the final correction data as the final data, and outputting a correction data allocation address allocating the final correction data in the data.

In one embodiment of the present invention, the encryption device is characterized in that the final data/code generation device includes: a correction data read instruction generation circuit for receiving the correction data allocation address from the final data generation circuit to generate a correction data read instruction for reading the final correction data allocated in the data; and a final instruction code generation circuit for receiving the dummy instruction codes, the instruction codes and the correction data read instruction from the correction data read instruction generation circuit to generate the final instruction codes in which the three instruction codes are allocated.

In one embodiment of the present invention, the encryption device is characterized in that the final instruction code generation circuit allocates the correction data read instruction and the dummy instruction codes in a part address range of the whole address range for storing the final instruction codes in the external memory.

In one embodiment of the present invention, the encryption device is characterized in that the final instruction code generation circuit stores the correction data read instruction and the dummy instruction codes in the external memory so that the correction data read instruction and the dummy instruction codes are interposed between two specific instruction codes.

In one embodiment of the present invention, the encryption device is characterized in that the final instruction code generation circuit stores the correction data read instruction and the dummy instruction code in the external memory so that the correction data read instruction and the dummy instruction codes are interposed between predetermined nth (where n is an integer) one of a plurality of the same specific instruction code and (n+1)th one of the specific instruction code.

An encryption system according to the present invention is characterized in that the encryption system includes: the encryption device; a development jig for performing an evaluation analysis of the semiconductor device; and an information processing terminal for checking a result of the evaluation analysis of the semiconductor device by the development jig, and the information processing terminal performs predetermined authentication and, if the authentication is rejected, makes the semiconductor device to execute instructions based on the dummy instruction codes.

A decryption device according to the present invention is a decryption device in a semiconductor system, the semiconductor system including a semiconductor device and an external memory, the external memory storing instruction codes and data for controlling the semiconductor device and dummy instruction codes obtained by encrypting confidential information to be a subject of protection against information leakage, and is characterized in that the decryption device reads out the dummy instruction codes from the external memory and decrypts the dummy instruction codes into the confidential information.

A semiconductor system according to the present invention is characterized by comprising: a semiconductor device; an external memory which stores instruction codes and data for controlling the semiconductor device and dummy instruction codes obtained by encrypting confidential information to be a subject of protection against information leakage; and a decryption device, provided in the semiconductor device, for reading out the dummy instruction codes from the external memory and decrypting the dummy instruction codes into the confidential information.

In one embodiment of the present invention, the decryption device or the semiconductor system is characterized in that in the external memory, confidential information of which corresponding instruction code does not exist is converted into another instruction code and stored as a dummy instruction code, and correction data for reconstructing the confidential information from the dummy instruction code, and correction data read instruction for reading out the correction data are also stored.

In one embodiment of the present invention, the decryption device or the semiconductor system is characterized in that the decryption device includes: a decryption circuit for receiving the dummy instruction code and the correction data stored in the external memory and decrypting the dummy instruction code and the correction data into the confidential information; and an instruction control device for controlling decryption by the decryption circuit.

In one embodiment of the present invention, the decryption device or the semiconductor device is characterized in that in the external memory, the dummy instruction codes and the correction data read instruction are stored in a predetermined address range.

In one embodiment of the present invention, the decryption device or the semiconductor system is characterized in that in the external memory, the dummy instruction codes and the correction data read instruction are stored so that the dummy instruction codes and the correction data read instruction are interposed between first and second specific codes.

In one embodiment of the present invention, the decryption device or the semiconductor system is characterized in that in the external memory, the dummy instruction codes and the correction data read instruction are stored so that the dummy instruction codes and the correction data read instruction are interposed between predetermined nth (where n is an integer) one of a plurality of the same specific instruction codes and (n+1)th one of the specific instruction codes.

In one embodiment of the present invention, the decryption device or the semiconductor system is characterized in that the instruction control device includes: upper and lower address resisters for designating the predetermined address range in which the dummy instruction codes and the correction data read instruction are stored in the external memory; an address comparison circuit for comparing an address input to the external memory to the upper and lower addresses of the upper and lower address resisters, and generating, when the input address is in the predetermined address range, the correction data write-in signal to output the correction data write-in signal to the decryption device and after a predetermined time, generating and outputting a decryption signal; and an instruction code output circuit for receiving the decryption signal of the address comparison circuit and outputting the dummy instruction codes read out from the external memory and a dummy instruction write-in signal to the decryption circuit and a no-operation instruction code to the semiconductor device.

In one embodiment of the present invention, the decryption device or the semiconductor system is characterized in that the instruction control device includes: an instruction code judgment circuit for receiving an instruction code read out from the external memory, if it is judged that the received instruction code is the first specific instruction code, generating the correction data write-in signal to output the correction data write-in signal to the decryption device and, after a predetermined time, generating a decryption signal, and if it is judged that the received instruction code is the second specific instruction code, stopping output of the decryption signal; and an instruction code output circuit for receiving the decryption signal output from the instruction code judgment circuit, during receiving the decryption signal, outputting the dummy instruction codes read out from the external memory and a dummy instruction write-in signal to the decryption circuit and a no-operation instruction code to the semiconductor device.

In one embodiment of the present invention, the decryption device or the semiconductor device is characterized in that the instruction control device includes: an instruction code judgment circuit for receiving an instruction code read out from the external memory, comparing the number of times of receipt of the instruction code to a predetermined number, generating the correction data write-in signal to output the correction data write-in signal to the decryption circuit and generating the decryption signal after a predetermined time when the receipt number matches the predetermined number, and outputting an instruction to stop output of the decryption signal when the receipt number no longer matches the predetermined number; and an instruction code output circuit for receiving the decryption signal output from the instruction code judgment circuit, during receiving the decryption signal, outputting the dummy instruction codes read out from the external memory and a dummy instruction write-in signal to the decryption circuit, and outputting a no-operation instruction code to the semiconductor device.

In one embodiment of the present invention, the decryption device or the semiconductor system is characterized in that the decryption device includes an interrupt control device for generating an interrupt signal and outputting the interrupt signal, and the instruction code output circuit of the instruction control device receives the interrupt signal of the interrupt control device, and during receiving the interrupt signal, stopping output of the dummy instruction codes and the dummy instruction write-in signal to the decryption circuit and outputting the instruction codes read out from the external memory to the semiconductor device.

As has been described, according to the present invention, in a semiconductor system including a semiconductor device and an external memory, confidential information stored in the external memory is stored not as data but as an converted dummy instruction code for the semiconductor device. Thus, even if a malicious third person analyzes data stored in the external memory, confidential information converted into instruction codes can not be distinguished from original instruction codes, and thus excellent protection of confidential information can be achieved.

### BRIEF DESCRIPTION OF THE DRAWINGS

FIG. 1 is a block diagram illustrating an entire structure of a semiconductor system including an encryption device and a decryption device according to an embodiment of the present invention.

FIG. 2 is a block diagram illustrating an internal structure of a data/code conversion device provided in the semiconductor system.

FIG. 3 is a flow chart of the operation of the data/code conversion device.

FIG. 4 is a block diagram illustrating an internal structure of a final data/code generation device provided in the data/code conversion device.

FIG. 5 is a flow chart of the operation of a correction data conversion circuit provided in the final data/code generation device.

FIG. 6 is an illustration showing a manner in which a dummy instruction code and correction data are stored in an external memory provided in the semiconductor system of FIG. 1.

FIG. 7 is an illustration showing another manner in which a dummy instruction code and correction data are stored in the external memory.

FIG. 8 is an illustration showing still another manner in which a dummy instruction code and correction data are stored in the external memory.

FIG. 9 is a block diagram illustrating an internal structure of an instruction control device in the semiconductor device provided in the semiconductor system of FIG. 1.

FIG. 10 is a block diagram illustrating another internal structure of the instruction control device.

FIG. 11 is a diagram illustrating still another internal structure of the instruction control device.

### DESCRIPTION OF THE PREFERRED EMBODIMENTS

Hereinafter, embodiments of the present invention will be described with reference to the accompanying drawings.

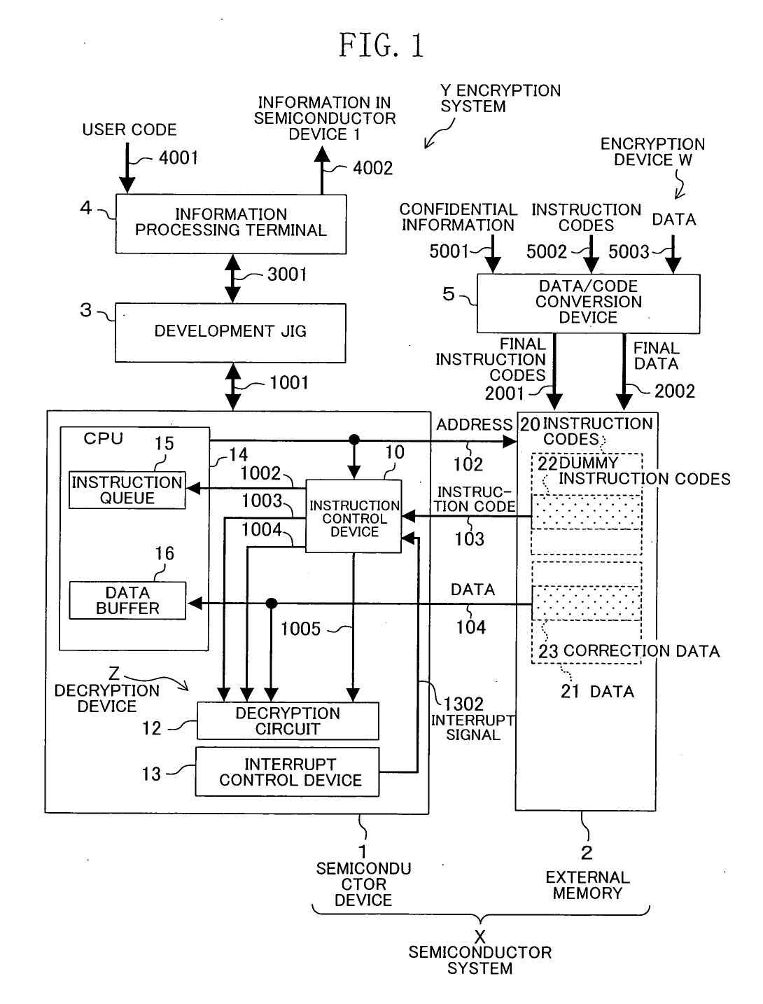

FIG. 1 is a block diagram illustrating the entire structures of an encryption system and a semiconductor system according to an embodiment of the present invention.

In FIG. 1, the reference numeral 1 denotes a semiconductor device and the reference numeral 3 denotes a development jig such as an on-chip debugger. Herein, the development jig 3 has the function of tracing a hardware resource in the semiconductor device 1 in order to develop software for the semiconductor device 1 and the like, and a result of the trace can be checked with an information processing terminal 4 connected to the development jig 3. The information processing terminal 4 is a device including the data input/output function, such as a keyboard and a monitor, and can be realized by personal computer or the like.

Moreover, the reference numeral 5 denotes a data/code conversion device (code conversion device) to which confidential information 5001 to be a subject of protection against information leakage, an instruction code 5002 for controlling the semiconductor device 1, and data 5003 to be used in the semiconductor device 1 are input and which constitutes an encryption device W. The data/code conversion device 5 outputs a final instruction code 2001 and final data 2002. The final instruction code 2001 and the final data 2002 are written into an external memory 2. The development jig 3, the information processing terminal 4 and the data/code conversion device 5 of FIG. 1 are used in system development. The data/code conversion device 5, the development jig 3 and the information processing terminal 4 together form a decryption system Y.

In the external memory 2, an instruction code 20 indicates the final instruction code 2001 and data 21 indicates the final data 2002. A dummy instruction code 22 existing in the instruction code 20 and correction data 23 existing in the data 21 will be described later.

The semiconductor device 1 and the external memory 2 together form a semiconductor system X. A CPU 14 in the semiconductor device 1 outputs an address 102, reads out an instruction code 103 and data 104 from the external memory 2 and stores the instruction code 103 and the data 104 in an instruction queue 15 and a data buffer 16, respectively. Moreover, the CPU 14 performs necessary processing based on an instruction code stored in the instruction queue 15. An instruction control device 10, which will be described later, has the function of controlling the outputs of the instruction code 103 and the data 104 to the CPU 14 and the decryption circuit 12. An interrupt control device 13 has the function of outputting an interrupt signal 1302 to the instruction control device 10 to request an interrupt to the CPU 14. The instruction control device 10, the decryption circuit 12 and the interrupt control device 13 disposed in the semiconductor device 1 together form a decryption device Z.

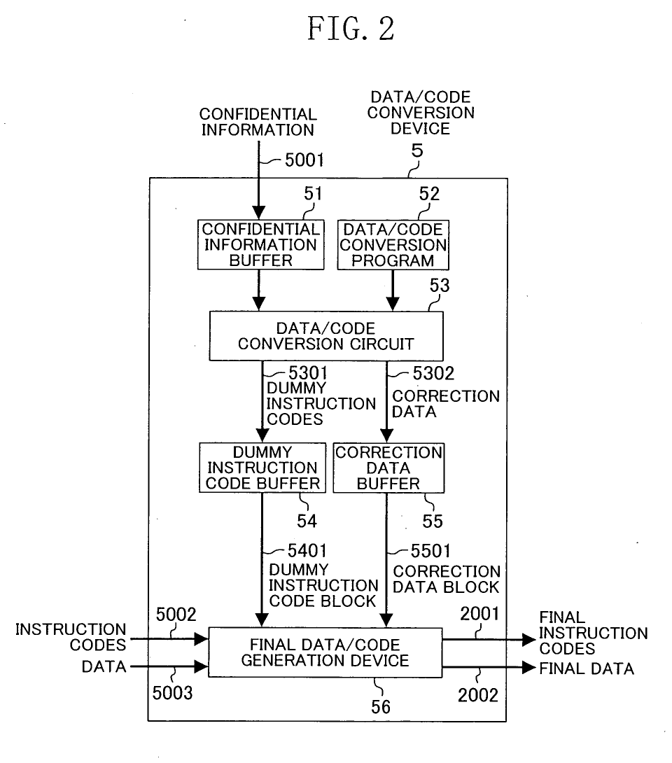

FIG. 2 is a block diagram illustrating the structure of the data/code conversion device 5. In FIG. 2, the externally input confidential information 5001 is stored in a confidential information buffer 51 in the data/code conversion device 5. A data/code conversion program 52 is a program including an algorithm for converting the confidential information 5001 into a dummy instruction code 5301. A data/code conversion circuit (conversion circuit) 53 generates the dummy instruction code 5301 using the confidential information in the confidential information buffer 51 and the data/code conversion program 52. Moreover, when conversion of the confidential information 5001 into the dummy instruction code 5301 is difficult, the data/code conversion circuit 53 corrects the confidential information 5001 to generate the dummy instruction code 5301 and also generates the corrected information as correction data 5302. Herein, the case where conversion of the confidential information 5001 into the dummy instruction code 5301 is difficult is assumed to be the care where a confidential information code is an instruction code which does not exist in the semiconductor device 1 or like cases. The generated dummy instruction code 5301 is stored in a dummy instruction code buffer 54 and the correction data 5302 is stored in a correction data buffer 55.

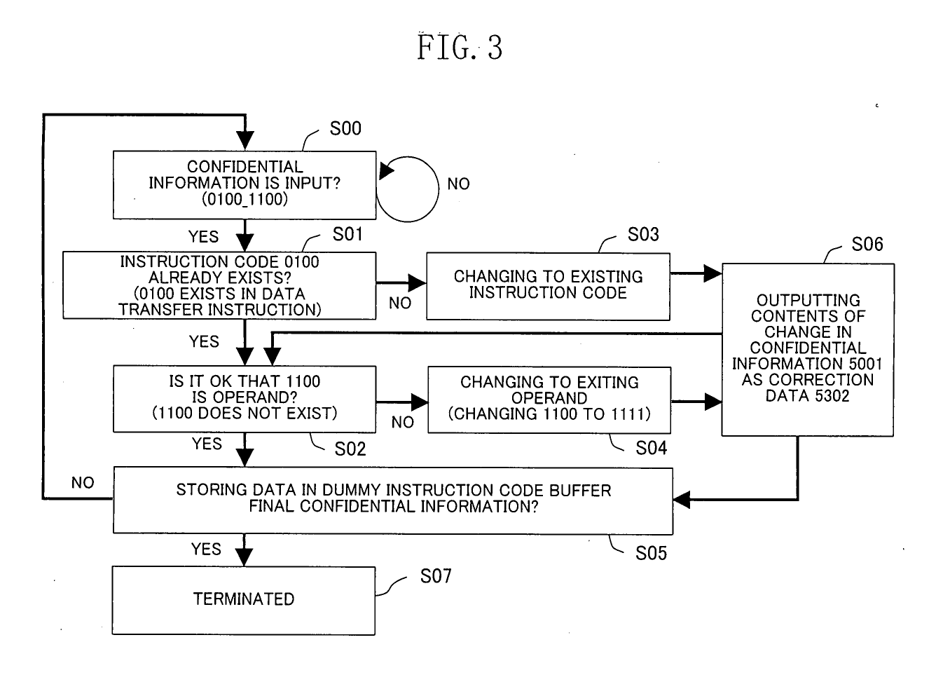

Hereafter, the operation of the data/code conversion circuit 53 will be described with reference to FIG. 3. FIG. 3 is a flow chart showing steps from the step of inputting the confidential information 5001 to the step of generating the dummy instruction code 5301 and the correction data 5302. Herein, the confidential information 5001 input to the data/code conversion device 5 is “0100_{—}1100” in the binary system. Moreover, an instruction code of the semiconductor device 1 is formed of a 4-bit operation code and a 4-bit operand. The data/code conversion circuit 53 allocates the highest 4 bits of the confidential information 5001 to the operation code and the lowest 4 bits of the confidential information 5001 to the operand. Furthermore, it is assumed that in the operation code, “0100” matches a data transfer instruction of the semiconductor device 1 and it is prohibited that the operand becomes “1100” in the data transfer instruction.

In FIG. 3, the reference numerals S00 through S07 denote states of the data/code conversion circuit 53 and at startup, the data/code conversion circuit 53 is in State S00 of waiting for an input of the confidential information 5001. When the confidential information 5001 is input, the state of the data/code conversion circuit 53 is changed from State S00 to State S01 and whether or not the highest 4 bits of the confidential information 5001 matches an existing instruction code using the data/code conversion program 52 is checked. In this case, “0100” matches a data transfer instruction of the semiconductor device 1 and thus the state of the data/code conversion circuit 53 is changed to State S02. On the other hand, if “0100” does not match a data transfer instruction of the semiconductor device 1, the state is changed from State S00 to State S03 and the highest 4 bits of the confidential information 5001 are changed to an appropriate numeral value of some other instruction code. When the change of the 4 bits is completed, the state is changed from State S03 to State S06, contents of the change is output as the correction data 5302 and then the state is changed from State S06 to State S02. In the above-described manner, the operation code of the dummy instruction code 5301 is determined.

Next, in State S02, whether or not “1100”, i.e., the lowest 4 bits of the confidential information 5001 are appropriate as an operand of an instruction code is checked. In this case, since it is prohibited to allocate “1100” to an operand of the data transfer instruction, the state is changed from State S02 to State S04 and a value of the operand is changed to an appropriate value. Thereafter, the state is changed from State S04 to State S06, contents of the change is output as the correction data 5302 and the state is changed from State S06 to State S05. Moreover, if the lowest 4 bits of the confidential information are appropriate as an operand in the State S02, the state is changed from State S02 to State S05. In State S05, the obtained operand is stored in the dummy instruction code buffer 54. In the above-described manner, the operand of the dummy instruction code 5301 is determined.

Thereafter, in State S05, whether or not the input confidential information code 5001 is final is judged. If the confidential information code 5001 is final, the state is changed from State S05 to State S07 and the conversion operation is terminated. If the confidential information code 5001 is not final, the state is changed from State S05 to State S00 and the data/code conversion circuit 53 becomes in the state of waiting for a next input of the confidential information 5001. The dummy instruction code 5301 and the correction data 5302, generated in the above-described manner, are stored in the dummy instruction buffer 54 and the correction data buffer 55, respectively. What has been described above is the operation of the data/code conversion circuit 53.

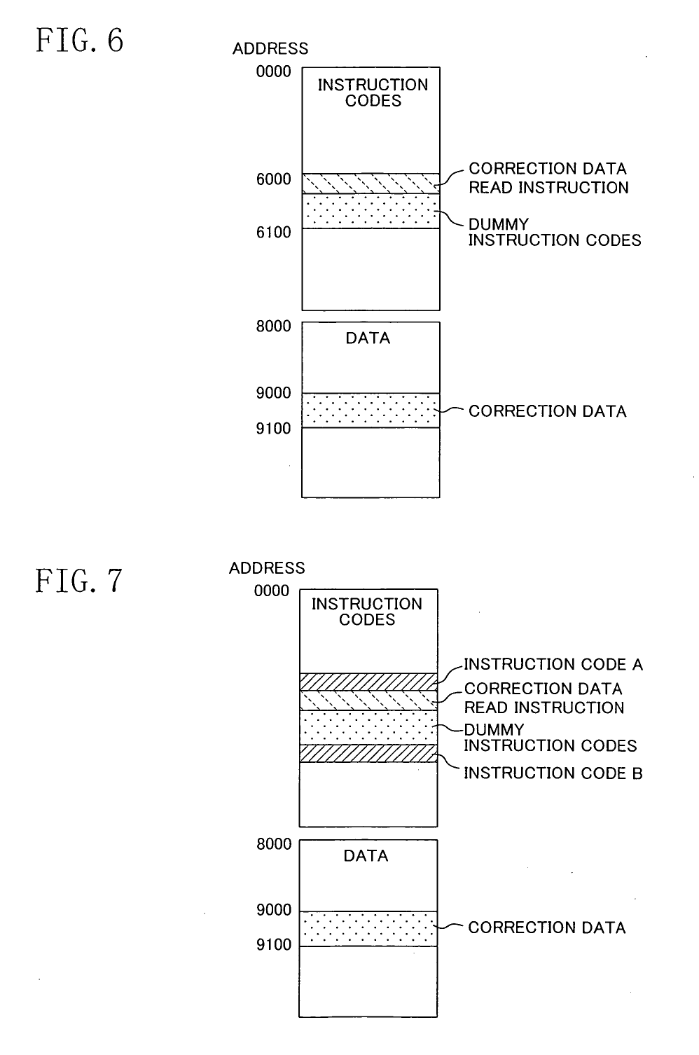

Next, a final data/code generation device 56 of FIG. 2 will be described. In FIG. 2, a dummy instruction code block 5401 and a correction data block 5501 are block data including the plurality of dummy instruction codes 5301 and block data including the plurality of correction data 5302, respectively. The final data/code generation device 56 receives the two block data 5401 and 5501, the instruction code 5002 and the data 5003 and outputs final instruction codes 2001 and final data 2002. Now, before details of the internal structure of the final data/code generation device 56 is described, memory structures of each of the final instruction code 2001 and the final data 2002 in the external memory 2 will be described with reference to FIGS. 6, 7 and 8.

FIGS. 6, 7 and 8 are illustrations of memory structures stored in the external memory device 2. In FIG. 6, a correction data read instruction, dummy instruction codes, and correction data are stored at pre-designated addresses, respectively. The semiconductor device 1 reads the dummy instruction codes and the correction data according to the addresses. Herein, the correction data read instruction is an instruction to make the semiconductor device 1 read the correction data 23. The step of generating the correction data read instruction will be described later.

In FIG. 7, the dummy instruction codes are interposed between a first specific instruction code A and a second specific instruction code B so that the location of the dummy instruction codes are indicated to the semiconductor device 1. In this case, the instruction codes A and B are shown as specific instruction code, but since the instruction codes A and B serve as identifiers for specifying the range of the dummy instruction codes, the instruction codes A and B can not be used in any other locations.

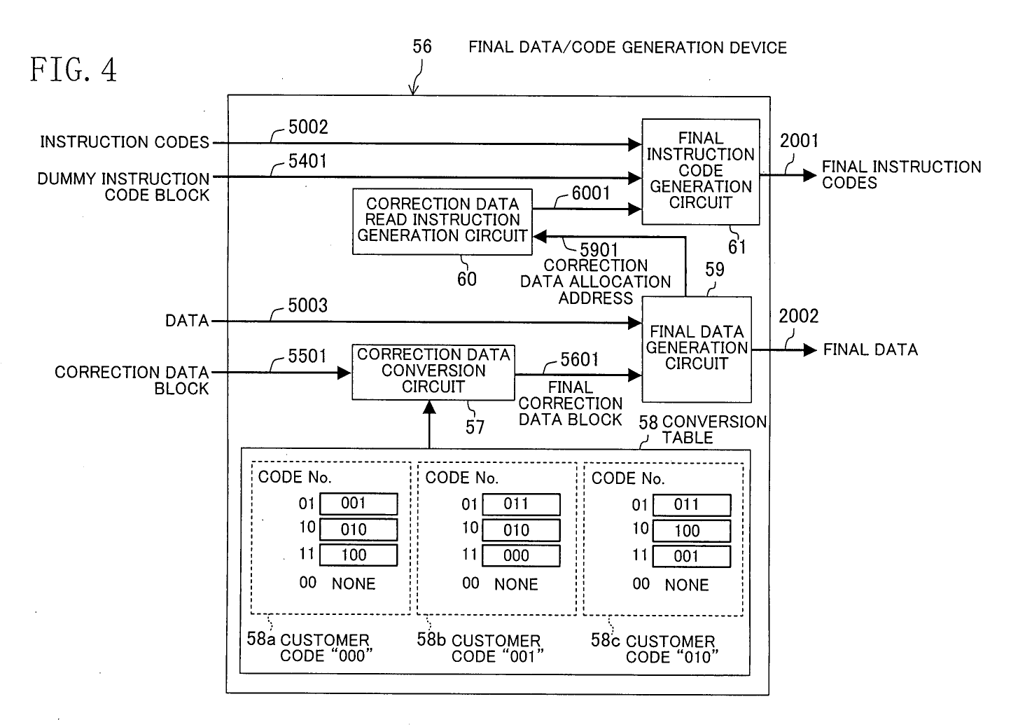

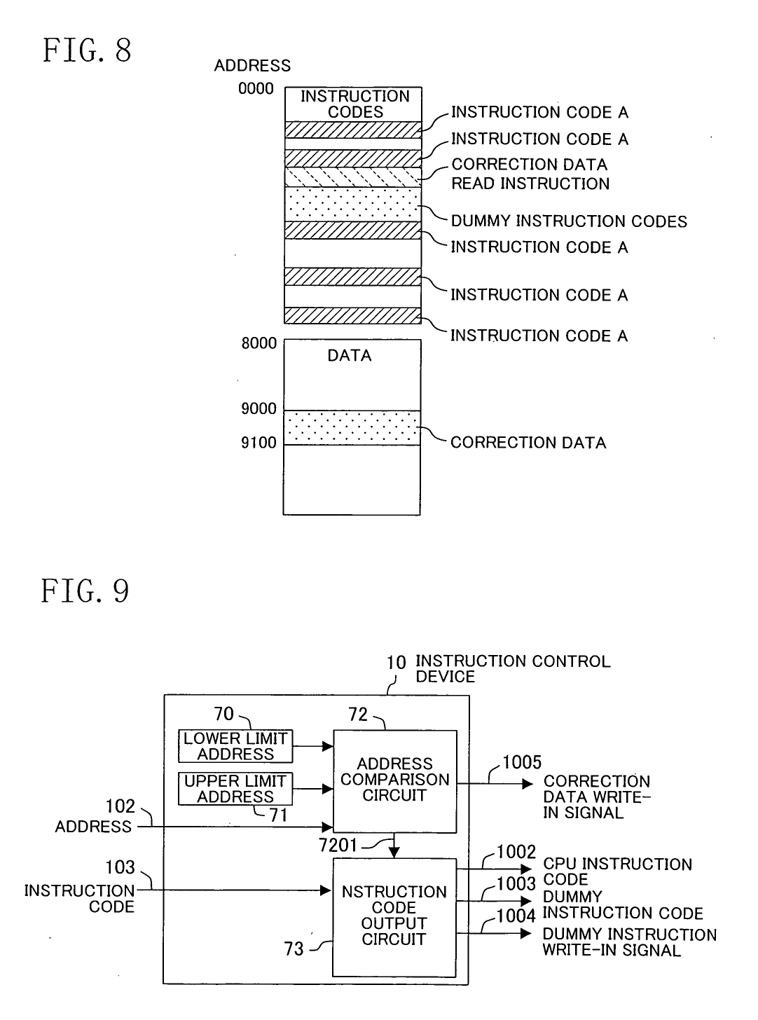

In FIG. 8, the dummy instruction codes are identified based on the appearance number of a specific instruction code. In this case, the specific instruction code A appears at five different locations. The dummy instruction codes are embedded between the second and third specific instruction codes A and the information of the embedment is incorporated into the correction data 23 to indicate the location of the dummy instruction codes to the semiconductor device 1. Hereafter, the internal structure of the final data/code generation device 56 will be described with reference to FIG. 4.

In FIG. 4, a correction data conversion circuit 57 performs data conversion of the correction data block 5501 according to a conversion table 58 to increase the security level. In FIG. 4, the conversion table 58 includes three conversion tables 58a, 58b and 58c for users A, B and C, respectively.

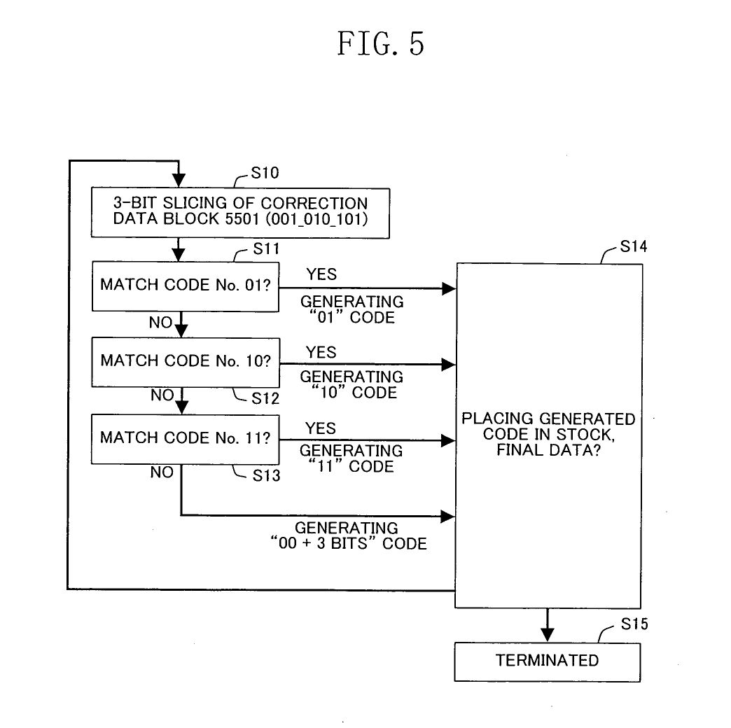

FIG. 5 is a flow chart showing a control flow of the correction data conversion circuit 57 and shows that, when each of the users A and B inputs the same correction data block 5501 to the correction data conversion circuit 57 using the control flow, different results for the generated final correction data block 5601 are obtained for the users A and B. In FIG. 5, the correction data block 5501 is assumed to be 9 bits, i.e., “011_{—}010_{—}101” in the binary system and the correction data conversion circuit 57 performs data conversion for every three bits according to the conversion table 58. In the conversion table 58 of FIG. 4, a customer code “000” corresponding to the conversion table 58a is allocated to the user A and a customer code “001” corresponding to the conversion table 58b is allocated to the user B. First, code conversion for the user A is performed.

The first three bits of the correction data block 5501, i.e., “011” do not match any one of code numbers “01”, “10” and “11”, and thus “00011” obtained by adding a “00”code indicating that there is no match to the three bits “011” is generated. Then, the process proceeds with Step S14. At this point, 6 bits still remain and therefore the process returns from Step S14 to S10 to perform the same code conversion as the previous time. Specifically, the next three bits “010” matches “010” of the code number “10” and the process proceeds with Step S12 to generate “10” and then the process proceeds with Step S14. The last three bits “101” do not match any one of the code numbers “01, “10” and “11”, and thus “00101” obtained by adding the “00” code indicating that there is no match to the three bits “101” is generated. Then, the process proceeds with Step S14. The conversion is completed in this stage, and thus the process proceeds from Step S14 to Step S15 and the conversion operation is terminated.

Through the above-described steps, in the case of conversion for the user A, data “011_{—}010_{—}101” of the correction data block 5501 is converted into data “00011_{—}10_{—}00101” of the final correction data block 5601. In the same manner, when a conversion operation is performed for the user B, the data “011_{—}010_{—}101” of the correction data block 5501 is converted into data “01_{—}10_{—}00101” of the final correction data block 5601.

In this manner, the data “011_{—}010_{—}101” of the correction data block 5501 is converted into a unique code of a variable-length for each user, so that the security level can be increased.

The final correction data block 5601 generated in the above-described manner is input with the data 5003 to the final data generation circuit 59 of FIG. 4, so that the final data 2002 is generated. Moreover, a correction data allocation address 5901, i.e., information for an allocation address of the final correction data block 5601 is output from the final data generation circuit 59. In a correction data read instruction generation circuit 60 of FIG. 4, an instruction 6001 to read the correction data 23 is generated according to the correction data allocation address 5901. The final instruction code generation circuit 61 receives the correction data read instruction 6001, the instruction code 5002 and the dummy instruction code block 5401 to generate a final instruction code 2001. The final instruction code 2001 and the final data 2002 generated in the above-described manner are stored in the external memory 2 of FIG. 1.

Next, the internal structure of the semiconductor device 1 of FIG. 1 will be described. In FIG. 1, the instruction control device 10 in the semiconductor device 1 outputs the instruction code 20 (103) read from the external memory 2 to the CPU 14 and the decryption circuit 12. Hereafter, the structure of the instruction control device 10 will be described with reference to FIGS. 9, 10 and 11. Note that memory structures of FIGS. 9, 10 and 11 are formed on the assumption that each of the memory structures of FIGS. 6, 7 and 8 are stored in the external memory 2.

FIG. 9 is a block diagram illustrating the structure of the instruction control device 10 in the case of reading instruction codes allocated in the manner shown in FIG. 6. A lower limit address of a lower limit address register 70 in FIG. 9 corresponds to an address 6000 of FIG. 6 and an upper limit address of an upper address register 71 corresponds to an address 60FF of FIG. 6. In FIG. 9, an address comparison circuit 72 compares an address 102 input from the CPU 14 to the lower address and the upper address. If the condition of the lower address<the address 102<the upper address is satisfied, the address comparison circuit 72 first asserts a correction data write-in signal 1005 asserted, outputs the correction data write-in signal 1005 to the decryption circuit 12, and then makes the decryption circuit 12 read the correction data 23 (104) of the external memory 2. When reading of the correction data 23 is completed after a predetermined time, the address comparison circuit 72 asserts a decryption signal 7201. With the decryption signal 7201 asserted, an instruction code output circuit 73 issues as a CPU instruction code 1002 a no-operation (NOP) instruction to the CPU 14, outputs received instruction codes 103 to the dummy instruction codes 1003 and a dummy instruction write-in signal 1004 to the decryption circuit 12. Thus, the decryption circuit 12 receives only the dummy instruction codes 1003 from the external memory 2 and the hardware resource of the CPU 14 is not changed while the decryption circuit 12 receives only the dummy instruction codes 1003.

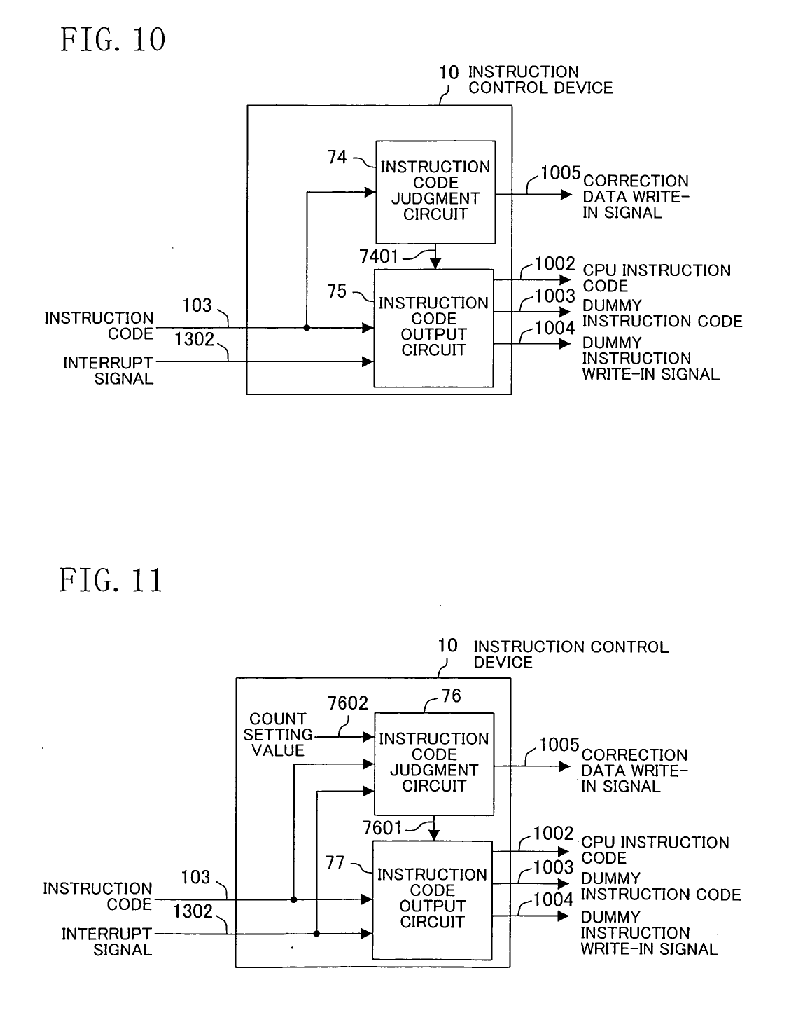

FIG. 10 is a block diagram illustrating the structure of the instruction control device 10 in the case of reading instruction codes disposed in the manner of FIG. 7. In FIG. 7, when the instruction code 103 is the first specific code A, an instruction code judgment circuit 74 of FIG. 10 first asserts a correction data input signal 1005, outputs the asserted correction data input signal 1005 to the decryption circuit 12 and makes the decryption circuit 12 read the correction data 23 (104). When reading of the correction data 23 is completed after a predetermined time, the instruction code judgment circuit 74 asserts the decryption signal 7401 and outputs the asserted decryption signal 7401. Then, when the instruction code 103 becomes the second specific instruction code B, the instruction code judgment circuit 74 negates the decryption signal 7401. With the decryption signal 7401 asserted, the instruction code output circuit 75 issues as the CPU instruction code 1002 a no-operation (NOP) instruction to the CPU 14 and outputs the instruction code 103 to the dummy instruction code 1003 and the dummy instruction write-in signal 1004 to the decryption circuit 12. Thus, the decryption circuit 12 receives only the dummy instruction codes 22 and the hardware resource of the CPU 14 is not changed while the decryption circuit 12 receives only the dummy instruction code. Moreover, while the interrupt signal 1302 is asserted from the interrupt control device 13 of FIG. 1, the instruction code output circuit 75 outputs as the CPU instruction code 1002 the received instruction code 103 to the CPU 14 and stops output of the dummy instruction codes 1003 and the dummy instruction write-in signal 1004 to the decryption circuit 12.

FIG. 11 is a block diagram illustrating the structure of the instruction control device 10 in the case of reading instruction codes disposed in the manner of FIG. 8. An instruction code judgment circuit 76 of FIG. 11 counts the number of times of appearances of the specific instruction code A to be input from the instruction codes 103 and compares the count value of the appearance number to a count setting value 7602 for defining the appearance number of the dummy instruction codes. If the count value matches the count setting value 7602, the instruction code judgment circuit 76 first asserts the correction data write-in signal 1005, outputs the asserted correction data write-in signal 1005 to the decryption circuit 12 and then makes the decryption circuit 12 read the correction data 23. Then, when the reading of the correction data 23 (104) is completed after a predetermined time, the instruction code judgment circuit 76 asserts the decryption signal 7601, and when the appearance number of the specific instruction code A no longer matches the count value, the instruction code judgment circuit 76 negates the decryption signal 7601.

Herein, the count setting value 7602 is data allocated to the semiconductor device 1 or the external memory 2. With the decryption signal 7601 asserted, the instruction code output circuit 77 issues as a CPU instruction code 1002 a no-operation (NOP) instruction to the CPU 14 and outputs the instruction codes 103 to the dummy instruction codes 1003 and the dummy instruction write-in signal 1004 to the decryption circuit 12. Thus, the decryption circuit 12 receives only the dummy instruction codes 22 and the hardware resource of the CPU 14 is not changed while the decryption circuit 12 receives only the dummy instruction codes. Moreover, while the interrupt signal 1302 is asserted from the interrupt control device 13 of FIG. 1, the instruction code output circuit 77 outputs as the CPU instruction code 1002 the instruction code 103 to the CPU 14 and stops output of the dummy instruction codes 1003 and the dummy instruction write-in signal 1004 to the decryption circuit 12.

Finally, the development jig 3 and the information processing terminal 4 of FIG. 1 will be described. In general, as for the semiconductor device 1 including an on-chip debugger or the like, an internal state of the semiconductor device 1 can be checked by the information processing terminal 4. However, during the checking, the internal state of the CPU 14 is not changed even though the dummy instruction code is executed, and thus the semiconductor device 1 tends to be a subject to be analyzed. In this case, in FIG. 1, authentication is performed with a user code 4001. If the authentication has been completed normally, the CPU 14 is stopped in execution of the dummy instruction codes. If the authentication is rejected, the CPU 14 executes the dummy instruction codes as instructions. With this structure, analysis of confidential information by a malicious user can be prevented.

1. An encryption device for encrypting confidential information in an external memory for storing instruction codes and data for controlling a semiconductor device and the confidential information to be a subject of protection against information leakage,
the semiconductor device and the external memory together composing a semiconductor system,
the encryption device comprising:
a code conversion device for converting the confidential information into the instruction codes and storing in the external memory the confidential information as dummy instruction codes.

2. The encryption device of claim 1, wherein the code conversion device includes a conversion circuit for converting, when an instruction code corresponding to the confidential information does not exist, the confidential information into another instruction code to generate a dummy instruction code, and generating correction data for reconstructing the confidential information from the dummy instruction code.

3. The encryption device of claim 2, wherein the code conversion device includes a final data/code generation device for receiving the dummy instruction code, the correction data, the instruction codes and the data and having the dummy instruction codes embedded in the instruction codes and the correction data embedded in the data to generate final instruction codes and final data to be stored in the external memory.

4. The encryption device of claim 3, wherein the final data/code generation device includes: a plurality of conversion tables for converting the correction data into the final correction data; and
a correction data conversion circuit for converting the correction data into final correction data using one of the plurality of conversion tables.

5. The encryption device of claim 4, wherein the final data/code generation device includes a final data generation circuit for receiving final correction data from the correction data conversion circuit and the data, allocating the final correction data in the data to output the data including the final correction data as the final data, and outputting a correction data allocation address allocating the final correction data in the data.

6. The encryption device of claim 5, wherein the final data/code generation device includes:
a correction data read instruction generation circuit for receiving the correction data allocation address from the final data generation circuit to generate a correction data read instruction for reading the final correction data allocated in the data; and
a final instruction code generation circuit for receiving the dummy instruction codes, the instruction codes and the correction data read instruction from the correction data read instruction generation circuit to generate the final instruction codes in which the three instruction codes are allocated.

7. The encryption device of claim 6, wherein the final instruction code generation circuit allocates the correction data read instruction and the dummy instruction codes in a part address range of the whole address range for storing the final instruction codes in the external memory.

8. The encryption device of claim 6, wherein the final instruction code generation circuit stores the correction data read instruction and the dummy instruction codes in the external memory so that the correction data read instruction and the dummy instruction codes are interposed between two specific instruction codes.

9. The encryption device of claim 6, wherein the final instruction code generation circuit stores the correction data read instruction and the dummy instruction codes in the external memory so that the correction data read instruction and the dummy instruction codes are interposed between predetermined nth (where n is an integer) one of a plurality of the same specific instruction code and (n+1)th one of the specific instruction code.

10. An encryption system comprising:
the encryption device of claim 1;
a development jig for performing an evaluation analysis of the semiconductor device; and
an information processing terminal for checking a result of the evaluation analysis of the semiconductor device by the development jig,
wherein the information processing terminal performs predetermined authentication and, if the authentication is rejected, makes the semiconductor device to execute instructions based on the dummy instruction codes.

11. A decryption device in a semiconductor system,
the semiconductor system including a semiconductor device and an external memory,
the external memory storing instruction codes and data for controlling the semiconductor device and dummy instruction codes obtained by encrypting confidential information to be a subject of protection against information leakage,
wherein the decryption device reads out the dummy instruction codes from the external memory and decrypts the dummy instruction codes into the confidential information.

12. A semiconductor system comprising:
a semiconductor device;
an external memory which stores instruction codes and data for controlling the semiconductor device and dummy instruction codes obtained by encrypting confidential information to be a subject of protection against information leakage; and
a decryption device, provided in the semiconductor device, for reading out the dummy instruction codes from the external memory and decrypting the dummy instruction codes into the confidential information.

13. The decryption device or the semiconductor system of claim 11 or claim 12, wherein in the external memory, confidential information of which corresponding instruction code does not exist is converted into another instruction code and stored as a dummy instruction code, and correction data for reconstructing the confidential information from the dummy instruction code, and correction data read instruction for reading out the correction data are also stored.

14. The decryption device or the semiconductor system of claim 13, wherein the decryption device includes:
a decryption circuit for receiving the dummy instruction code and the correction data stored in the external memory and decrypting the dummy instruction code and the correction data into the confidential information; and
an instruction control device for controlling decryption by the decryption circuit.

15. The decryption device or the semiconductor system of claim 14, wherein in the external memory, the dummy instruction codes and the correction data read instruction are stored in a predetermined address range.

16. The decryption device or the semiconductor system of claim 14, wherein in the external memory, the dummy instruction codes and the correction data read instruction are stored so that the dummy instruction codes and the correction data read instruction are interposed between first and second specific codes.

17. The decryption device or the semiconductor system of claim 14, wherein in the external memory, the dummy instruction codes and the correction data read instruction are stored so that the dummy instruction codes and the correction data read instruction are interposed between predetermined nth (where n is an integer) one of a plurality of the same specific instruction code and (n+1)th one of the specific instruction code.

18. The decryption device or the semiconductor system of claim 15, wherein the instruction control device includes:
upper and lower address resisters for designating the predetermined address range in which the dummy instruction codes and the correction data read instruction are stored in the external memory;
an address comparison circuit for comparing an address input to the external memory to the upper and lower addresses of the upper and lower address resisters, and generating, when the input address is in the predetermined address range, the correction data write-in signal to output the correction data write-in signal to the decryption device and after a predetermined time, generating and outputting a decryption signal; and
an instruction code output circuit for receiving the decryption signal of the address comparison circuit and outputting the dummy instruction codes read out from the external memory and a dummy instruction write-in signal to the decryption circuit and a no-operation instruction code to the semiconductor device.

19. The decryption device or the semiconductor system of claim 16, wherein the instruction control device includes:
an instruction code judgment circuit for receiving an instruction code read out from the external memory, if it is judged that the received instruction code is the first specific instruction code, generating the correction data write-in signal to output the correction data write-in signal to the decryption device and, after a predetermined time, generating a decryption signal, and if it is judged that the received instruction code is the second specific instruction code, stopping output of the decryption signal; and
an instruction code output circuit for receiving the decryption signal output from the instruction code judgment circuit, during receiving the decryption signal, outputting the dummy instruction codes read out from the external memory and a dummy instruction write-in signal to the decryption circuit and a no-operation instruction code to the semiconductor device.

20. The decryption device or the semiconductor system of claim 17, wherein the instruction control device includes:
an instruction code judgment circuit for receiving an instruction code read out from the external memory, comparing the number of times of receipt of the instruction code to a predetermined number, generating the correction data write-in signal to output the correction data write-in signal to the decryption circuit and generating the decryption signal after a predetermined time when the receipt number matches the predetermined number, and outputting an instruction to stop output of the decryption signal when the receipt number no longer matches the predetermined number; and
an instruction code output circuit for receiving the decryption signal output from the instruction code judgment circuit, during receiving the decryption signal, outputting the dummy instruction codes read out from the external memory and a dummy instruction write-in signal to the decryption circuit, and outputting a no-operation instruction code to the semiconductor device.

21. The decryption device or the semiconductor system of claim 19 or claim 20, wherein the decryption device includes an interrupt control device for generating an interrupt signal and outputting the interrupt signal, and
wherein the instruction code output circuit of the instruction control device receives the interrupt signal of the interrupt control device, and during receiving the interrupt signal, stopping output of the dummy instruction codes and the dummy instruction write-in signal to the decryption circuit and outputting the instruction codes read out from the external memory to the semiconductor device.
